(19) United States
(12) Patent Application Publication
(10) Pub. No.: US 2022/0316696 A1
(43) Pub. Date: Oct. 6, 2022

(54) EVAPORATOR OF A WORKING FLUID FOR AN OTEC PLANT COMPRISING A COVER

(71) Applicant: NAVAL GROUP, Paris (FR)

(72) Inventor: Bertrand CLAUZADE, Paris (FR)

(21) Appl. No.: 17/596,728

(22) PCT Filed: Jun. 17, 2020
(86) PCT No.: PCT/EP2020/066759

§ 371 Date: Dec. 16, 2021

(30) Foreign Application Priority Data
Jun. 17, 2019 (FR) FR1906457

(51) Int. Cl. F22B 27/16; F28F 9/02; F28F 9/00; F03G 7/05

(52) U.S. Cl. CPC F22B 27/16; F28F 9/0224; F28F 9/001; F03G 7/05

(57) ABSTRACT

The present invention relates to an evaporator of a working fluid for an OTEC plant, comprising an elongated evaporator body extending along a main axis, a bundle of evaporators transporting hot water, a sprinkling system arranged in an upper part of the evaporator body, a system for evacuating the fluid in gaseous state and a guide system for the fluid in gaseous state towards the evacuation system. The guide system comprises an elongated cover extending along the main axis, covering the bundle of evaporators and the sprinkling system, and two partitioning means which are arranged at each end of the evaporator body and form on each of these ends a sealed connection between the outer surface of the cover and the inner surface of the evaporator body.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present invention relates to an evaporator of a working fluid for an OTEC plant.

### BACKGROUND

In a manner known per se, an OTEC (for Ocean Thermal Energy Conversion) plant uses the temperature difference between the surface water and the deep water of the oceans to produce electricity.

Typically, such an OTEC plant comprises an evaporator, in which a working fluid is evaporated by the warm surface waters to drive a turbine, and a condenser, in which this working fluid is then condensed by the cold waters of the ocean floor.

The evaporator of an OTEC plant generally has an elongated body through which a bundle of evaporators extends. This bundle of evaporators, in the form of a plurality of pipes or plates, circulates hot water along the evaporator. A sprinkling system consisting of pipes and nozzles mounted on the pipes is provided along this bundle in order to sprinkle working fluid, in a liquid state, onto it. The nozzles are generally arranged homogeneously along the corresponding pipes.

The evaporator body, also known as the shell in the state of the art, not only acts as a pressurized container but also guides the working fluid evaporated by the bundle of evaporators to an evacuation system.

In horizontal falling film evaporator applications, the sprinkling system is located below the evacuation system. Thus, the fluid in liquid state, falling by gravity on the bundle of evaporators, rises again after its evaporation to the evacuation system.

In such a case, the shell alone is insufficient to guide the steam efficiently, and a specific guide system is therefore provided.

This guide system generally comprises a component covering the bundle of evaporators and isolating the working fluid, still in liquid state, from the steam. This component, known in the state of the art as a “casing”, is fixed to the shell at a distance from it to form a sealed channel for the passage of the steam.

However, due to different thermal expansions between the casing and the shell, the channel formed between them is not perfectly sealed. Thus, some working fluid can pass through these imperfections, which decreases the efficiency of the OTEC plant. Furthermore, this can lead to droplets forming and driving on the turbine.

### SUMMARY

The object of the present invention is to provide an evaporator whose casing ensures a particularly effective isolation between the fluid in liquid state and the steam, and thus increases the efficiency of the OTEC plant.

To this end, the subject matter of the invention is an evaporator of a working fluid for an OTEC plant, comprising:
an elongated evaporator body, extending along a main axis between two ends, defining an inner surface, an upper part, an intermediate part and a lower part, and comprising two side walls extending between the lower part and the upper part on either side of the main axis;
a bundle of evaporators, transporting hot water and extending along the main axis;
a sprinkling system, arranged in the upper part of the evaporator body above the bundle of evaporators and capable of sprinkling the working fluid in liquid state onto the bundle of evaporators, in order to transform it into a gaseous state
a system for evacuating the fluid in gaseous state arranged in the upper part of the evaporator body above the sprinkling system; and
a system for guiding the fluid in gaseous state to the evacuation system.

The guide system comprises:
an elongated cover, extending along the main axis, covering the bundle of evaporators and the sprinkler system in the upper and intermediate parts of the evaporator body, and defining an outer surface, a longitudinal opening being formed in the lower part of the evaporator body between each of the side walls and the cover;
two partitioning means arranged each end of the evaporator body and forming at each a sealed connection of these ends. between the outer surface of the cover and the inner surface of the evaporator body.

According to further advantageous aspects of the invention, the evaporator comprises one or more of the following features, taken alone or in any technically possible combination:
each partitioning means takes the form of a plate, cut in a “U” shape, defining an inner contour in contact with the cover, an outer contour in contact with the inner surface of the evaporator body and a partition extending between the inner contour and the outer contour;
the partition of each of said plates is perpendicular to the main axis;
the outer and inner contour of one of said plates are sealed to the inner surface of the evaporator body and to the outer surface of the cover, respectively;
the inner or outer contour of one of said plates is sealed to the outer surface of the cover or to the inner surface of the evaporator body and the other contour of this plate, called the free contour, is in sealed contact with the inner surface of the evaporator body or the outer surface of the cover;
the free contour is able to slide along the inner surface of the evaporator body or along the outer surface of the cover;
the free contour comprises a sealing joint, ensuring the seal between the free contour and the corresponding surface;
the cover has a “U”-shaped bent sheet;
the cover defines a substantially flat part facing each side wall; and
a channel for the passage of the working fluid in a gaseous state between each longitudinal opening and the evacuation system is delimited by the outer surface of the cover, the inner surface of the evaporator body and the two partitioning means.

### BRIEF DESCRIPTION OF THE DRAWINGS

These features and advantages of the invention will become apparent from the following description, given only as a non-limiting example, and made with reference to the appended drawings, in which:

FIG. 1 is a schematic side view of an evaporator according to the invention, the evaporator comprising a guide system in particular;

FIG. 2 is a schematic cross-sectional view of the evaporator in FIG. 1 according to the sectional plane II-II visible in this FIG. 1; and

FIG. 3 is a schematic perspective view of the guide system of FIG. 1.

### DETAILED DESCRIPTION

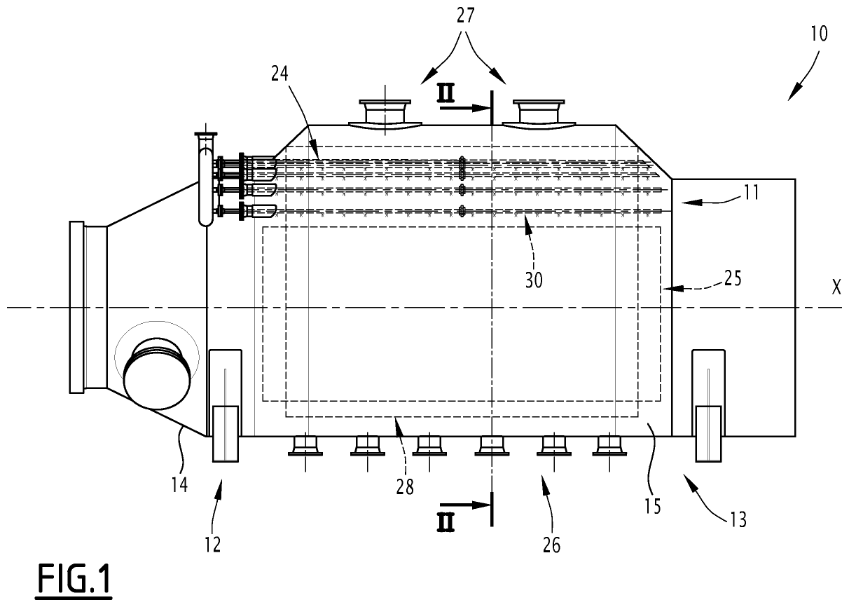

In fact, an evaporator 10 for an OTEC plant has been shown in FIG. 1. In the illustrated example, the evaporator 10 is a pipe evaporator. According to other embodiments, the evaporator is a plate evaporator.

With reference to FIG. 1, the evaporator 10 has an evaporator body 11 extended along a major axis X between a first end 12 and a second end 13.

At the first end 12, the evaporator body 11 has a substantially conical shape 14 opening into a substantially cylindrical shape 15 defining the second end 13.

The evaporator body 11 is pressurized, for example, and may also be referred to in the terminology used in the prior art as a shell.

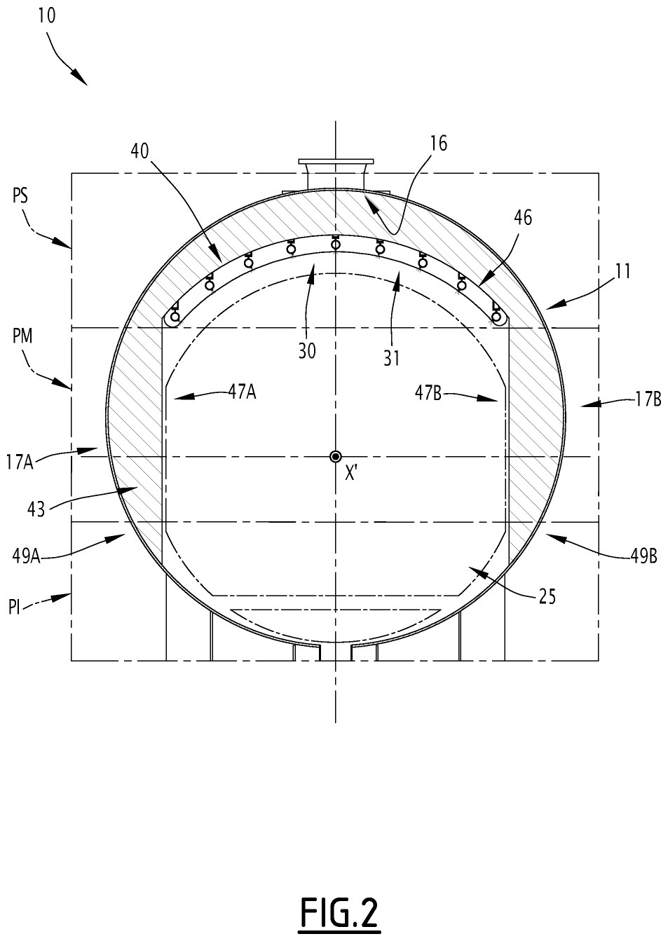

In each cross-section of the cylindrical part 15 (one of which is visible in FIG. 2), the evaporator body 11 defines an upper part PS, an intermediate part PM and a lower part PI.

The evaporator body 11 further defines an inner surface 16 delimiting the interior of said body and two side walls 17A, 17B.

As visible in FIG. 2, the side walls 17A, 17B extend between the lower part PI and the upper part PS, on either side of the main axis X along said axis X.

Referring again to FIG. 1, the evaporator 10 comprises a sprinkler system 24, a bundle of evaporators 25, a channeling system 26, an evacuation system 27, and a guide system 28.

The sprinkling system 24 is arranged in the upper part PS of the evaporator body 11 and comprises a supply network and a plurality of sprinkling nozzles arranged on this supply network.

In particular, in the example of FIGS. 1 and 2, the supply network takes the form of a plurality of supply pipes 30.

Within the evaporator body 11, each supply pipe 30 extends along the main axis X above the bundle of evaporators 25. Thus, in FIG. 1, the parts of these pipes extending inside the body 11 are shown as broken lines and the parts extending outside the body 11 are shown as solid lines.

Furthermore, as can be seen in cross-section in FIG. 2, the supply pipes 30 are arranged on an arc of a circle 31. This arc 31 is formed by suitable support means. arranged at each end 12, 13 of the evaporator body 11, for example.

The opening of this arc of a circle 31 is between 80° and 160°, for example.

In addition, the supply pipes 30 are evenly distributed along this arc, for example.

Thus, in the example shown in FIG. 2, nine supply pipes 30 distributed homogeneously along the arc 31 are shown.

The bundle of evaporators 25 takes the form of a plurality of pipes passing through the cylindrical part 15 of the body 11 along the main axis X. These pipes are a few thousand in number, for example, such as 3000 in number. Thus, for reasons of legibility of FIG. 1, these pipes are not shown in this Figure.

The pipes of the bundle of evaporators 25 transport water, called warm water, i.e. surface water. This water circulates in the bundle of evaporators 25 along the main axis X, from left to right in the example of FIG. 1, for example.

Thus, when a working fluid sprinkled via the sprinkling system 24 comes into contact with the pipes of the bundle 25, it vaporizes.

The channeling system 26 allows the non-vaporized working fluid to be channeled back into the evaporator 10 via the sprinkling system 24, for example.

This channeling system 26 is arranged in the lower part PI of the evaporator body 11, below the bundle of evaporators 25.

The evacuation system 27 is used to evacuate steam produced by the bundle of evaporators 25 and to guide it to a (non-illustrated) turbine, for rotation.

This evacuation system 27 is arranged in the upper part PS of the evaporator body 11, above the sprinkler system 24 and thus above the bundle of evaporators 25.

The evacuation system 27 takes the form of a plurality of channels passing through the evaporator body 11 in the upper part thereof, for example.

The guide system 28 is used to guide the working fluid in a gaseous state to the evacuation system 27.

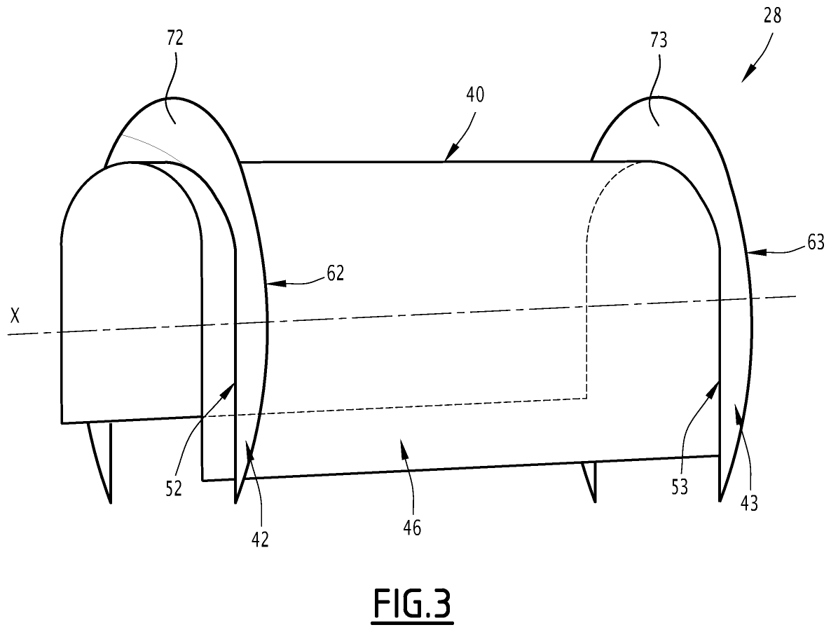

For this purpose, the guide system 28 comprises a cover 40 and at least two partitioning means 42, 43, as can be seen in FIG. 3, showing a perspective view of this system. The cover 40 and the partitioning means 43 are also visible in cross-section in FIG. 2.

The cover 40 is elongated, extends along the main axis X and covers the bundle of evaporators 25 and the sprinkling system 24 in the upper part PS and intermediate part PM of the evaporator body 11.

In particular, in the illustrated example, the cover 40 has a “U”-shaped bent sheet metal. This sheet metal defines an outer surface 46 which, in turn, defines at least two substantially planar parts 47A, 47B, visible in FIG. 2.

More generally, according to other embodiments, the cover 40 has any other shape covering the sprinkling system 24 and the evaporator bundle 25.

Each of these planar parts 47A, 47B is arranged opposite one of the side walls 17A, 17B of the evaporator body 11.

In the simplified example of FIGS. 2 and 3, the planar parts 47A, 47B have a substantially rectangular shape, extending along the main axis X.

According to other embodiments, these parts 47A, 47B may have any other shape chosen in particular depending on the shape of the evaporator body 11. Thus, for example, when the evaporator body 11 has a conical shape at its ends, the parts 47A, 47B may follow this shape.

The cover 40 is arranged away from the inner surface 16 of the evaporator body 11 so as to form a channel for the passage of steam.

This channel opens in the lower part PI of the evaporator body 11 onto two longitudinal openings 49A, 49B, formed between the cover 40 and the side walls 17A, 17B, and in the upper part PS of the evaporator body 11, on the evacuation system 27.

In particular, each longitudinal opening 49A, 49B is formed between one of the side walls 17A, 17B and the planar part 47A, 47B of the cover 40 corresponding to that side wall 17A, 17B.

Each of the partitioning means 42, 43 takes the form of a plate cut out in a “U” shape, defining an inner contour 52, 53 respectively, an outer contour 62, 63 respectively and a partition 72, 73 respectively.

Each inner contour 52, 53 is in sealed contact with the outer surface 46 of the cover 40 and each outer contour 62, 63 is in sealed contact with the inner surface 16 of the evaporator body 11.

Each wall 72, 73 extends between the corresponding inner contour 52, 53 and outer contour 62, 63, substantially perpendicular to the main axis X, for example.

Thus, the walls 72, 73 define and complete the channel for passage of steam formed between the outer surface 46 of the cover 40 and the inner surface 16 of the evaporator body 11.

The cover 40 is held away from the inner surface 16 of the evaporator body 11 by the partition means 43.

In particular, this partitioning means 43 corresponding to the end 13 of the evaporator body 11 is sealed between the cover 40 and the evaporator body 11, for example.

In other words, in this case, the inner contour 53 of this means 43 is sealed to the outer surface 46 of the cover 40 and the outer contour 63 is sealed to the inner surface 16 of the evaporator body 11. This attachment is made by angle welding, for example.

The partition means 42 corresponding to the end 12 of the evaporator body 11 is sealed to the evaporator body 11 and is in free contact with the cover 40.

In this case, the outer contour 62 is sealed by welding, for example, to the inner surface 16 of the evaporator body 11 and the inner contour 52 is in free contact with the outer surface 46 of the cover 40. In this case, the inner contour 52 is said to be free contour.

Thus, during longitudinal expansions of the cover 40, the inner contour 52 is able to slide along the outer surface 46 of the cover 40 along the main axis X.

The seal between the inner contour 52 and the outer surface 46 of the cover 42 is ensured by a metal-to-metal type sealing contact, for example, or by a seal provided for this purpose between these parts.

In a variant, the inner contour 52 of the partitioning means 42 is fixed to the outer surface 46 of the cover 40 and the outer contour 62 is thus in free contact with the inner surface 16 of the evaporator body 11.

In this case, the outer contour 62 is thus said to be a free contour, capable of sliding along the inner surface 16 of the evaporator body 11 and ensuring sealing either by metal-to-metal contact or through a seal provided for this purpose with this surface 16.

Of course, it is possible to provide a partitioning means with a free contour (analogous to the partitioning means 42) at the end 13 of the evaporator body 11 and a partitioning means with the two contours fixed (analogous to the partitioning means 43) at the end 12 of the evaporator body 11. It is also possible to arrange these partitioning means in different parts of the evaporator body 11 than the ends 12, 13.

It is then conceivable that the present invention has a number of advantages.

Indeed, in the evaporator according to the invention, the partitioning means of the cover, used to isolate the fluid in a liquid state with the steam makes it possible for the cover to expand along the main axis independently of the evaporator body.

Thus, the seal of the steam guide channel is not broken, which allows the fluid in liquid state to be effectively isolated from the fluid in gaseous state.

It is thus clear that the guidance system within the meaning of the invention makes it possible to decorrelate the sealing function with expansion of the intersection function of the shapes of the cover and the evaporator body, particularly in its conical part.

This then makes it possible to increase the efficiency of the turbine and more generally, the efficiency of the OTEC plant.

1. An evaporator of a working fluid for an OTEC plant, comprising:
an evaporator body of elongated shape, extending along a main axis between two ends, defining an inner surface, an upper part, an intermediate part and a lower part and comprising two side walls extending between the lower part and the upper part on either side of the main axis;
a bundle of evaporators for transporting hot water and extending along the main axis;
a sprinkling system arranged in the upper part of the evaporator body above the bundle of evaporators and able to sprinkle the working fluid in liquid state onto the bundle of evaporators, in order to transform the working fluid into a gaseous state;
a system for evacuating the working fluid in gaseous state, arranged in the upper part of the evaporator body above the sprinkling system; and
a system for guiding fluid in gaseous state to the system for evacuating;
wherein the guide system comprises:
a cover of elongated shape, extending along the main axis, covering the bundle of evaporators and the sprinkling system in the upper and intermediate parts of the evaporator body, and defining an outer surface, a longitudinal opening being formed in the lower part of the evaporator body between each of the sidewalls and the cover; and
two partitions arranged at each end of the evaporator body and forming a sealed connection at each of these ends, between the outer surface of the cover and the inner surface of the evaporator body.

2. The evaporator according to claim 1, wherein each partition takes the form of a “U”-shaped cut-out plate defining an inner contour in contact with the cover, an outer contour in contact with the inner surface of the evaporator body, and a partition extending between the inner contour and the outer contour.

3. The evaporator according to claim 2, wherein the partition of each of said plates is perpendicular to the main axis.

4. The evaporator according to claim 2, wherein the outer contour and the inner contour of one of said plates are sealed to the inner surface of the evaporator body and to the outer surface of the cover, respectively.

5. The evaporator according to claim 2, wherein the inner contour or the outer contour of one of said plates is sealed to the outer surface of the cover or to the inner surface of the evaporator body and the other contour of this plate is sealed to the inner surface of the evaporator body or the outer surface of the cover.

6. The evaporator according to claim 5, wherein the other contour is able to slide along the inner surface of the evaporator body or along the outer surface of the cover.

7. The evaporator according to claim 5, wherein the other contour comprises a seal providing a seal between the free contour and the corresponding surface.

8. The evaporator according to claim 1, wherein the cover has a “U” shaped bent sheet.

9. The evaporator according to claim 8, wherein the cover defines a substantially planar part facing each sidewall.

10. The evaporator according to claim 1, wherein a channel for passage of the working fluid in gaseous state, between each longitudinal opening and the evacuation system, is delimited by the outer surface of the cover, the inner surface of the evaporator body and the two partitions.
